(19) United States
(12) Patent Application Publication
(10) Pub. No.: US 2004/0026420 A1
(43) Pub. Date: Feb. 12, 2004

(54) Rotatable dispenser closure for use with a container

(75) Inventor: Ernest L. Smith, Kansas City, MO (US)

Correspondence Address: William B. Kircher, SHOOK, HARDY & BACON L.L.P., One Kansas City Place, 1200 Main Street, Kansas City, MO, 64105-2118, US

(73) Assignee: Huhtamaki Consumer Packaging, Inc.

(21) Appl. No.: 10/632,726

(22) Filed: Aug. 1, 2003

Related U.S. Application Data
(60) Provisional application No. 60/400,484, filed on Aug. 1, 2002.

(51) Int. Cl. B65D 51/18; B67D 3/00

(52) U.S. Cl. 220/253; 222/548; 222/553; 222/554

(57) ABSTRACT

A container having a rotatable dispenser closure is disclosed. The container has a body portion and a closure portion. The container body has at its upper end a closure securing section that is folded inwardly and downwardly so that it is in contact with the inner surface of the body sidewall. The closure includes a sidewall having a lower section, an upper section and a first rim. The lower section of the closure sidewall fits snugly against the interior of the body sidewall below the closure securing section, the upper section of the closure sidewall engages the closure securing section, and the first rim of the closure sidewall rests on the top of the closure securing section. In this manner, the closure is coupled to the container body so that the closure is prevented from upward or downward movement but not axial rotation. Both the body sidewall and the closure sidewall contain apertures that are positioned so that they may be aligned when the closure is rotated. With the apertures aligned, product stored inside the container may be poured from the container.

### CROSS-REFERENCE TO RELATED APPLICATIONS

This application claims priority pursuant to 35 U.S.C. Section 119 from United States Provisional Application No. 60/400,484 filed Aug. 1, 2002.

### STATEMENT REGARDING FEDERALLY SPONSORED RESEARCH OR DEVELOPMENT

Not applicable.

### BACKGROUND OF THE INVENTION

The present invention provides a closure for a container. More specifically, the present invention provides a reclosable dispenser closure for a container.

Producers provide consumer items, including powered or granulated solids and free-flowing or somewhat viscous materials, in numerous different types of containers. For some containers, access is gained to the interior by opening the entire top of the container. Other containers have an area that may be separated from the container wall or top to allow access to the interior of the container. One example of this second type of container is a container having an opening defined at least in part by a perforation line. Unfortunately, it is difficult to reseal or reclose these types of containers to maintain the freshness of the product. Thus, many containers include some type of reclosable dispenser. One common type of a reclosable dispenser is a retractable plastic or metal pour spout. However, although effective, pour spouts generally require specialized equipment to manufacture and assemble and, therefore, are expensive.

An optimal dispensing means is easy to use and is reclosable for those situations when only a portion of the stored product is utilized. Often this dispensing means is part of a separate closure portion that is coupled to a container body. For example, one common type of reclosable closure is a rotatable dispenser. Existing rotatable dispensers, however, are not necessarily easy to use. Specifically, currently, rotatable dispensers have apertures in their top end so that a user must substantially upend the container before the product stored therein will pour from the container. Utilizing containers having such dispensers is awkward and difficult, especially in situations where a user must shake the container to coax the contents out.

Thus, a cost effective, easy-to-use reclosable closure is needed. More particularly, a cost effective, easy-to-use, container mounted, rotatable, reclosable dispenser closure that is suitable to store and dispense powered or granulated solids and free-flowing or somewhat viscous materials, including food products closure is needed.

### SUMMARY OF THE INVENTION

The present invention encompasses a container that includes a rotatable dispenser closure. The container has a body portion and a closure portion. At the top of the container body sidewall is a closure guide securing section that is folded inwardly and downwardly so that it is in contact with the inner surface of the body sidewall. The closure includes a sidewall with a lower section, an upper section and a first rim. When installed, the lower section of the closure sidewall fits snugly against the interior of the body sidewall below the folded over closure securing section, the upper section of the closure sidewall fits snugly against the closure securing section, and the first rim of the closure sidewall rests on the top of the closure securing section and body sidewall. In this manner, the closure is securely coupled to the container body so that the closure is prevented from upward or downward movement but not axial rotation. Both the body sidewall and the closure sidewall contain apertures that are positioned so that they may be aligned when the closure is rotated. With the apertures aligned, product stored inside the container may be poured from the container.

Additional objects, advantages, and novel features of the invention will be set forth in part in the description which follows, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

In the accompanying drawings which form a part of the specification and are to be read in conjunction therewith and in which like reference numerals are used to indicate like parts in the various views:

FIG. 1 is a top perspective view of a container with a rotatable dispenser closure according to one embodiment of the present invention with part of the container body sidewall broken away and shown in section to reveal details of the sidewall and the closure;

FIG. 2 is a top perspective view of the rotatable dispenser closure shown in FIG. 1 with part of the closure sidewall broken away and shown in section to reveal details of the closure;

FIG. 3 is a top plan view of the container shown in FIG. 1 with part of the closure top broken away to reveal details of the closure;

FIG. 4 is an enlarged fragmentary side sectional view of the container shown in FIG. 1 taken along line 4-4 in FIG. 1;

FIG. 5 is a side sectional view of the container shown in FIG. 1 taken along line 5-5 in FIG. 1;

FIG. 6 is a side sectional view of the container shown in FIG. 3 taken along line 6-6 in FIG. 3;

FIG. 7 is a top perspective view of a container with a rotatable dispenser closure according to one embodiment of the present invention;

FIG. 8 is a top plan view of the container shown in FIG. 7;

FIG. 9 is an enlarged side fragmentary sectional view of the container shown in FIG. 8 taken along line 9-9 in FIG. 8;

FIG. 10 is a side sectional view of the container shown in FIG. 7 taken along line 10-10 in FIG. 7; and

FIG. 11 is a side sectional view of the container shown in FIG. 7.

### DETAILED DESCRIPTION OF THE INVENTION

The present invention comprises a container that includes a body portion and a rotatable dispenser closure. The closure engages a closure securing section located at the upper end of the body portion's sidewall. The closure securing section is folded inwardly and downwardly so that it fits snugly against the inner surface of the body portion's sidewall. When installed, the closure is prevented from moving upward or downward but axial rotation is allowed. By rotating the closure, an aperture in the closure sidewall may be aligned with an aperture in the body sidewall so that the contents of the container may be dispensed. Further rotation causes the body sidewall to block the aperture in the closure sidewall.

Referring now to FIG. 1, a container with a rotatable dispenser closure according to one embodiment of the present invention is shown. The container is referred to generally by the numeral 10. Container 10 includes a body portion 20 with a rotatable closure 30 coupled thereto at the upper end of body portion 20. Preferably, container body 20 is made from paperboard convolutely formed in the shape of a cylinder and closure 30 is made from a thermoplastic material, such as polyethylene or polystyrene. Thus, container body 20 may be made by heat or pressure treating paperboard having a thermoplastic coating, and closure 30 may be made by injecting a thermoplastic material into an appropriately shaped mold. Of course, both container body 20 and closure 30 may be made from other materials or combination of materials.

Continuing with FIG. 1, container body 20 includes a cylindrical body sidewall 40 and a round bottom wall (not shown). A first aperture 50 extends through body sidewall 40. An aperture cover 60 is shown removed from first aperture 50. Before removal, aperture cover 60 covers first aperture 50. As is well known in the art, aperture cover 60 may be a paper member that is glued over first aperture 50 or may be a part of body sidewall 40 that is surrounded by perforation cuts with the cuts defining first aperture 50. At the top of body sidewall 40 is a closure securing section 70 that will be discussed in more detail below.

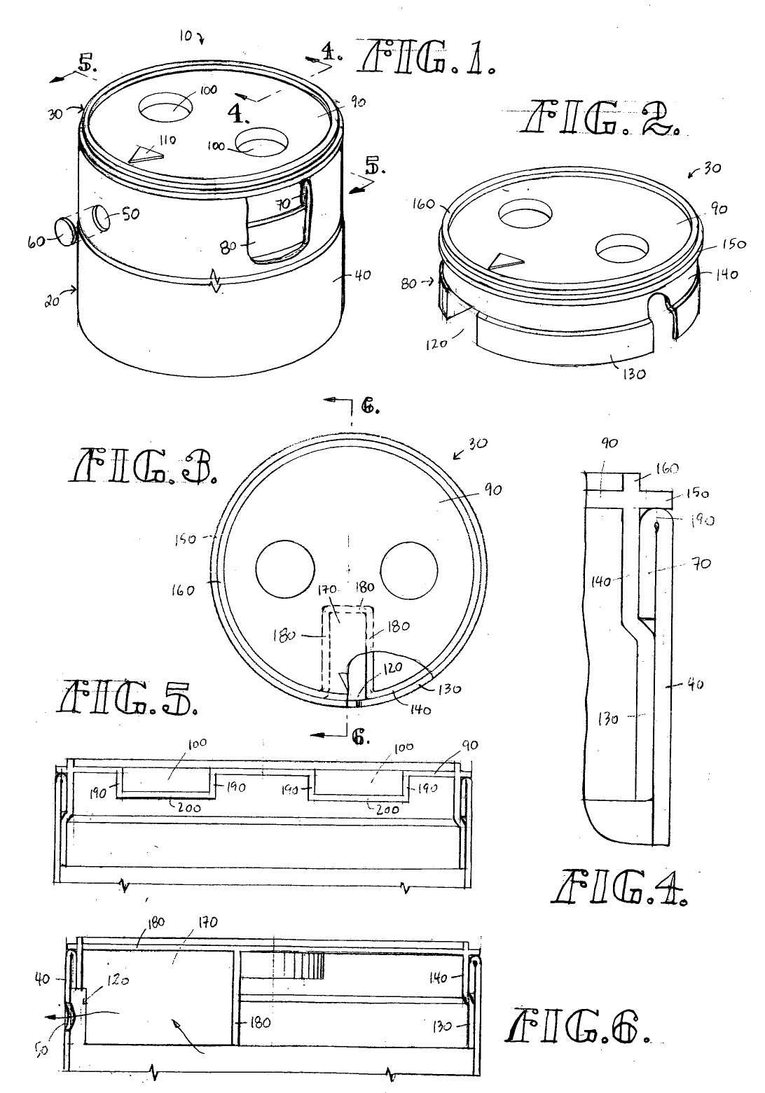

Closure 30 includes a generally cylindrical closure sidewall 80 and a round top wall 90. Top wall 90 includes a pair of finger notches 100 that may be utilized to rotate closure 30. Top wall 90 also includes a guide mark 110 that indicates the position of a second aperture 120 (see FIG. 2) located in closure sidewall 80.

In FIG. 2, closure 30 is shown removed from container body 20. Closure sidewall 80 includes a cylindrical lower section 130 that has an exterior diameter that is substantially equivalent to the interior diameter of body sidewall 40. Closure sidewall 80 also includes a cylindrical upper section 140 that is stepped back from lower section 130 so that it has a smaller diameter. The distance of this step back is approximately equal to the thickness of closure securing section 70 and body sidewall 40. The height of upper section 140 corresponds to the height of closure securing section 70. First rim 150 extends horizontally from the top of upper section 140, while second rim 160 extends vertically from the top of upper section 140.

In FIG. 3, a top plan view of a closure 30 with parts broken away and shown in section to reveal additional details is shown. As can be seen, three walls 180, aperture 120, and top wall 90 define a cavity 170. Cavity 170 is open both at aperture 120 and at its lowest side or floor so that when closure 30 is coupled to body portion 20 and positioned so that apertures 50 and 120 are aligned, a path is formed from the interior of the container through cavity 170 and apertures 120 and 50 to the outside of the container.

The manner in which closure 30 is coupled to container body portion 20 is shown in greater detail in FIG. 4. As can be seen, closure securing section 70 of body sidewall 40 is folded inwardly and downwardly so that it is in contact with the interior side of body sidewall 40. Closure lower section 130 fits snugly against the portion of first sidewall 40 that lies below closure securing section 70, while upper section 140 fits snugly against closure securing section 70, and first rim 150 rests on the top of fold 190. Thus, first rim 150 prevents closure 30 from moving down body sidewall 40, while lower portion 130 restricts closure 30 from moving upward. Closure 30, however, is not prevented from axial rotation.

FIG. 5 shows a sectional view of container 10. In this figure it can be seen that finger notches 100 are defined by walls 190 and floors 200. Finger notches 100 are sufficiently sized to allow insertion of the tips of a person's fingers. Thus, a person could insert one or two fingers into finger notches 100 and exert force in an axial direction to rotate closure 30. Finger notches 100 do not provide an access to the interior of container 10.

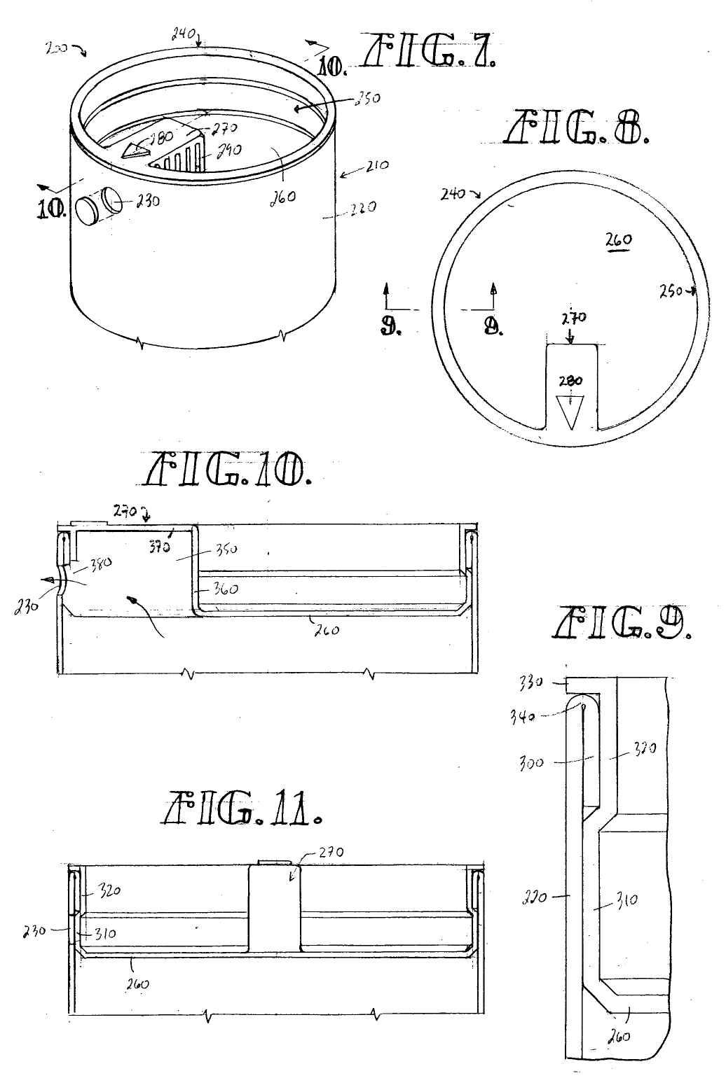

FIG. 6 also shows a sectional view of container 10 with closure 30 in the open position. In this figure, closure 30 has been rotated so that first aperture 50 is aligned with second aperture 120. It is from this position that product may be poured from container 10. When container 10 is tilted in the direction of first aperture 50, product will move in the direction indicated by the arrows in FIG. 6. Thus, product that is located in the interior of container 10 initially moves through cavity 170. As stated above, cavity 170 is defined in part by walls 180. However, as can be seen in FIG. 6, the bottom of cavity remains open to the interior of container 10. After moving through cavity 170, the product exits container 10 by passing through second aperture 120 and then through first aperture 50. In the closed position (not shown), lower portion 130 of closure sidewall 80 prevents product from passing through first aperture 50.

Another embodiment of the present invention is shown in FIG. 7. In this figure, a container generally by the numeral 200 is shown. Container 200 includes a body portion 210 that includes a cylindrical body sidewall 220. Body sidewall 220 includes a first aperture 230.

Container 200 also contains a rotatable dispenser closure generally indicated by the numeral 240. As is also shown in FIG. 8, closure 240 includes a generally cylindrical closure sidewall 250 and a substantially round bottom wall 260. Closure 240 also includes a cavity housing 270. On the top of the exterior of cavity housing 270 is a guide mark 280 that indicates the position of a second aperture 380 (see FIG. 10) located in closure sidewall 250. On the side of the exterior of cavity housing 270 are a plurality of gripping pads 290 that may aid in grasping cavity housing 270 when rotating closure 240. Gripping pads 290 may be formed from textured material that is glued or bonded to cavity housing 270 or may be formed from paint or other liquid containing a low strength adhesive or rough particles that is applied to cavity housing 270 and allowed to dry.

As shown in FIG. 9, closure 240 is connected to container body portion 210 in a manner similar to the manner in which closure 30 is connected to body portion 20. As can be seen, closure securing section 300 of body sidewall 220 is folded inwardly and downwardly so that it is in contact with the interior side of body sidewall 220. Regarding closure 240, lower portion 310 fits snugly against that portion of first sidewall 220 that lies below closure securing section 300, upper portion 320 engages closure securing section 300, and first rim 330 is positioned overtop of fold 340. Thus, first rim 330 prevents closure 240 from moving down body sidewall 220, while lower portion 310 prevents closure 240 from moving upward. Closure 240, however, is not prevented from axial rotation. In this embodiment, unlike container 10, bottom wall 260 is coupled to the bottom of lower portion 310. In container 10, top wall 90 is coupled to the top of upper portion 140 (see FIG. 4).

FIG. 10 shows a sectional view of container 200 with closure 240 in the open position. As can be seen, cavity housing 270 defines cavity 350. Cavity housing includes walls 360 and top 370. Walls 360 include a second aperture 380. In this figure, closure 240 has been rotated so that first aperture 230 is aligned with second aperture 380. It is from this position that product may be poured from container 200. When container 200 is tilted in the direction of first aperture 230, product will move in the direction indicated by the arrows in FIG. 10. Thus, product that is located in the interior of container 200 initially moves through cavity 350, passes through second aperture 380 and then through first aperture 230.

FIG. 11 shows a sectional view of container 200 with closure 240 in a closed position. In this position, lower portion 310 and bottom wall 260 prevent product from reaching first aperture 230.

The foregoing description is illustrative, and variations in configuration and implementation will occur to persons skilled in the art. It will be appreciated by such persons that the present invention is not limited to what has been particularly shown and described hereinabove. Additionally, from the foregoing, it will be seen that this invention is one well adapted to attain the ends and objects hereinabove set forth together with other advantages which are obvious and which are inherent to the structure. It will be understood that certain features and subcombinations are of utility and may be employed without reference to other features and subcombinations. This is contemplated by and is within the scope of the claims.

The invention claimed is:

1. A rotatable closure for a container comprising:
a generally cylindrical sidewall, said sidewall in part defining an aperture extending through said sidewall, said sidewall including a lower section and an upper section, said lower section having a smaller diameter than said upper section,
a circular top wall coupled to the top of said sidewall, said top wall extending substantially horizontally outward from said sidewall to form a first rim;
a cavity wall coupled to said top wall and to said sidewall at said aperture thereby forming an open-ended cavity.

2. The closure of claim 1 wherein said top wall further includes a first finger notch.

3. The closure of claim 2 wherein said top wall further includes a second finger notch.

4. The closure of claim 1 further including a guide mark positioned on said top wall overtop said cavity.

5. The closure of claim 1 wherein said closure is formed from plastic.

6. The closure of claim 1 further including a second rim coupled to the top of said sidewall and extending substantially vertically.

7. A container for storing consumer products, said container comprising:
a container body, said container body having a generally cylindrical body sidewall and a generally round bottom wall, said body sidewall having a closure securing portion at its top that is folded inwardly and downwardly so that it is in contact with the body sidewall portion below said closure securing portion, said body sidewall in part defining a first aperture extending through said sidewall; and
a closure portion coupled to said container body, said closure portion including a generally cylindrical closure sidewall, said closure sidewall in part defining a second aperture extending through said closure sidewall, said closure sidewall including a lower section and an upper section, said lower section having a smaller diameter than said upper section, said closure further including a circular top wall coupled to the top of said sidewall, said top wall extending substantially horizontally outward from said sidewall to form a first rim; said closure further including a cavity wall coupled to said top wall and to said sidewall at said aperture thereby forming an open-ended cavity;
wherein said lower section of said closure sidewall engages said body sidewall below said closure securing portion of said body sidewall so as to prevent upward movement of said closure portion and said first rim engages the top of said sidewall so as to prevent downward movement of said closure portion; and
wherein said closure portion may be axially rotated so that first aperture and second aperture are aligned.

8. The container of claim 7 wherein said closure top wall further includes a first finger notch.

9. The container of claim 8 wherein said closure top wall further includes a second finger notch.

10. The closure of claim 7 further including a guide mark positioned on said closure top wall overtop said cavity.

11. The container of claim 7 wherein said closure portion is formed from plastic.

12. The container of claim 7 wherein said body portion is formed from plastic.

13. The container of claim 7 wherein said body portion is formed from paperboard.

14. A rotatable closure for a container comprising:
a generally cylindrical sidewall, said sidewall in part defining an aperture extending through said sidewall, said sidewall including a lower section and an upper section, said lower section having a smaller diameter than said upper section, said sidewall including a rim coupled to the top of said sidewall, said rim extending substantially horizontally outward;
a circular bottom wall coupled to the bottom of said sidewall;
a cavity wall coupled to said bottom wall and to said sidewall at said aperture thereby forming an open-ended cavity.

15. The closure of claim 14 wherein said cavity wall include at least one grip pad.

16. The closure of claim 14 further including a guide mark positioned on said cavity wall.

17. The closure of claim 14 wherein said closure is formed from plastic.

18. A container for storing consumer products, said container comprising:
a container body, said container body having a generally cylindrical body sidewall and a generally round bottom wall, said body sidewall having a closure securing portion at its top that is folded inwardly and downwardly so that it is in contact with the body sidewall portion below said closure securing portion, said body sidewall in part defining a first aperture extending through said sidewall; and
a closure portion coupled to said container body, said closure portion including a generally cylindrical closure sidewall, said closure sidewall in part defining a second aperture extending through said closure sidewall, said closure sidewall including a lower section and an upper section, said lower section having a smaller diameter than said upper section, said sidewall including a rim coupled to the top of said sidewall, said rim extending substantially horizontally outward, said closure portion further including a circular bottom wall coupled to the bottom of said closure sidewall, said closure portion further including a cavity wall coupled to said bottom wall and to said sidewall at said aperture thereby forming an open-ended cavity;
wherein said lower section of said closure sidewall engages said body sidewall below said closure securing portion of said body sidewall so as to prevent upward movement of said closure portion and said rim engages the top of said sidewall so as to prevent downward movement of said closure portion; and
wherein said closure portion may be axially rotated so that first aperture and second aperture are aligned.

19. The closure of claim 18 wherein said cavity wall include at least one grip pad.

20. The closure of claim 18 further including a guide mark positioned on said cavity wall.

21. The closure of claim 18 wherein said closure is formed from plastic.

22. The container of claim 18 wherein said body portion is formed from plastic.

23. The container of claim 18 wherein said body portion is formed from paperboard.
